(19) United States
(12) Patent Application Publication
(10) Pub. No.: US 2013/0240209 A1
(43) Pub. Date: Sep. 19, 2013

(54) Cold Distillation Process and Apparatus

(71) Applicant: Walter Scarborough, Houston, TX (US)

(72) Inventor: Walter Scarborough, Houston, TX (US)

(21) Appl. No.: 13/620,828

(22) Filed: Sep. 15, 2012

Related U.S. Application Data
(60) Provisional application No. 61/535,270, filed on Sep. 15, 2011.
(60) Provisional application No. 61/557,695, filed on Nov. 9, 2011.
(60) Provisional application No. 61/598,184, filed on Feb. 13, 2012.

(51) Int. Cl. B01D 3/00; E21B 43/16; C02F 1/04

(52) U.S. Cl. CPC B01D 3/006; C02F 1/04; E21B 43/16
USPC 166/305.1; 202/185.1; 202/185.3; 203/10

(57) ABSTRACT

Apparatus and method for economically removing salts and heavy metals from water. The apparatus and method provide for flowing of the water across a transducer/resonator assembly which has enhanced resonation such that the water vaporizes and condenses without the salts or heavy metals. The water may then be used for drinking, irrigation, agricultural purposes, or injecting into subterranean formations related to mining or the recovery of hydrocarbons. The water may also be used to supplement or prepare water for reverse-osmosis desalination processes.

### RELATED APPLICATION

This application claims priority from the following three United States Provisional patent applications, which are all pending: U.S. Patent Application Ser. No. 61/535,270, filed Sep. 15, 2011, entitled “Cold Distillation Process”; U.S. Patent Application Ser. No. 61/557,695, filed Nov. 9, 2011, entitled “Cold Distillation Process”; and U.S. Patent Application Ser. No. 61/598,184, filed Feb. 13, 2012, entitled “Cold Distillation Process.”

### BACKGROUND OF THE INVENTION

1. Field of the Invention

The present invention relates to distillation and/or desalination apparatuses and methods or processes for removing salts, metals, and contaminants from water.

2. Description of Relevant Art

Many techniques have been proposed and used to remove salts and/or heavy metals and/or other contaminants from water. One of the oldest techniques for extracting fresh water from salt water or brine is distillation or evaporation. As salt water is boiled, the steam leaving the salt water is condensed and is essentially constituted of fresh water. While effective, steam distillation is energy intensive because of the heat required for the process.

Other techniques to desalinate water include freezing, reverse osmosis, and various chemical and electrostatic processes. Efforts at ultrasound for separation have also been reported but have been said to be limited by ultrasound generators being able to produce only 50 atmospheres of pressure during the compression cycle of the ultrasound wave. A sonic reactor in the form of a multistage centrifugal pump-like apparatus has been tried in an effort to overcome such limitations of ultrasound generators. All of these techniques and processes have been found to require substantial energy and thus have ultimately been considered too cost prohibitive to be widely used.

There continues to be a need for apparatuses and processes capable of removing salts and impurities such as heavy metals from water, to make it fit for human consumption without the need for massive energy to accomplish such removal. There is a further need for a water desalination/purification system that can be economically scaled in size to provide both small systems that can be economically operated as well as large commercial operations. Still further, there is a need for such water desalination/purification systems that can be operated on either a continuous or a batch process. Such systems have utility in converting sea water to potable water and also in treating water produced and/or used in recovering hydrocarbons and in mining operations.

### SUMMARY OF THE INVENTION

The present invention provides a system and method for removing salts, metals (especially heavy metals), and/or contaminants from an aqueous fluid, most commonly water. The system includes or combines a source of water, typically contained in a basin, tank or tub, usually in a measured, predetermined or known quantity, in a liquid state. This water source has integrated or associated with it, and in one embodiment at least partially submerged in it, at least one sled, such that the water flows over the sled. The sled includes or comprises at least one and most preferably a plurality of ultrasonic transducers which have associated with them at least one surrogate transducer. In preferred embodiments, each ultrasonic transducer has associated with it a surrogate transducer. In use, in the system and method of the invention, the ultrasonic transducers resonate within a range that causes the surrogate transducers to resonate within a range that causes at least some of the water to evaporate or vaporize. The water vapor enters a cloud chamber which directs the water vapor into a condenser or other holder for the water vapor condensed into water. This chamber is sufficiently long that only water vapor without a significant amount of salts, metals or contaminants for the intended use, reaches the condenser.

In one embodiment, the chamber has gills at a level above the water source for receiving an influx of air that avoids any outflow of the water vapor or water, and avoids any outflow of any salts, metals, or contaminants, into the external atmosphere. Such influx of air into the chamber through the gills moves the water vapor from the chamber into the condenser and enables condensing of the vapor into water.

In one embodiment, any unevaporated or unvaporized water remaining in the water source after flowing across the sled, flows into one or more discharge receivers. The water may then optionally be directed or routed to flow again across the sled.

### BRIEF DESCRIPTION OF THE DRAWINGS

FIG. 1 is a schematic view of one embodiment of a transducer/resonator assembly of the invention comprising three transducers.

FIG. 2 is a schematic view of another embodiment of a transducer/resonator assembly of the invention comprising one transducer.

FIG. 3 is an isometric view of one embodiment of a sled with a plurality of transducer/resonator assemblies of the invention installed for operation in one embodiment of the system of the invention.

FIG. 4 is an isometric view of one embodiment of the system of the invention with a side panel removed.

FIG. 5 is an isometric view of the composite of the embodiment of the system of the invention shown in FIG. 4 with a power pack and pump pack installed.

FIG. 6 is a cross-section view of the embodiment of the system of the invention shown in FIGS. 4 and 5.

FIG. 7 is a schematic of the water recirculation feature of one embodiment of the system of the invention.

### DETAILED DESCRIPTION OF PREFERRED EMBODIMENTS

The present invention provides a system and method for removing salts, metals and solid or composition type contaminants from aqueous fluids, and particularly water, and is especially useful in the utility and energy industries. Common nonlimiting examples of such utility of the invention include: desalinating sea water for irrigation and drinking; removing salts and metals from water produced with hydrocarbons in oil production, so the water may be reinjected into the subterranean formation or used for other purposes such as irrigation or drinking; and similar cleaning of “dirty” water associated with hydraulic fracturing for production of hydrocarbons from horizontally drilled shale formations. The invention might also be used to supplement known techniques for desalinating sea water, such as reverse-osmosis processing, to reduce the cost of those techniques. That is, for example, the invention might be used to prepare water for treatment by reverse-osmosis processing, by removing hydrocarbons or high salt concentrations that might make the water otherwise unsuitable (i.e., unfilterable) for reverse-osmosis processing.

Without limitation as to theory, it is believed that the invention achieves its purposes through principles of ultrasonic harmonic dispersion. In its simplest form, the invention employs at least one and most practically a plurality of transducer/resonator assemblies which cause the water in the aqueous fluid to vaporize or evaporate and rise toward a cloud chamber. The salts, metals and/or solid or composition type contaminants in the fluid either lack sufficient energy to rise out of the water or are too heavy to rise with the water vapor sufficiently high as to reach the cloud chamber. Consequently, the water vapor in the cloud chamber is sufficiently pure for the purposes of the invention. Preferably, this process is conducted in an enclosed and sealed container so that the water vapor will readily condense in the cloud chamber or in an adjacent condenser upon the introduction of air or other vacuum breaker in the cloud chamber.

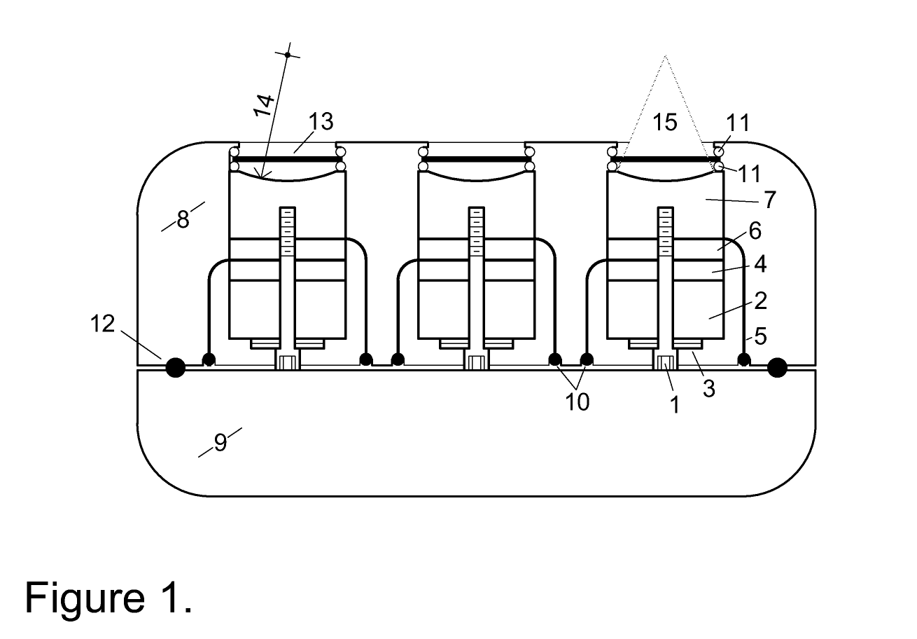

Referring to FIG. 1 for illustration of a preferred transducer/resonator assembly for one embodiment of the invention, a piezoelectric element 6 is positioned adjacent an insulator or insulation disc 4 that is supported by a backing plate 2 with compression washers 3. The piezoelectric element 6 is associated with an electrode 5 which receives electrical current or energy from wiring 10. A socket-head bolt or screw 1 extends through these components and up into a radiating bar transmitter 7 adjacent the piezoelectric element 6. The insulator disc 4 and socket-head bolt 1 resonate when energy is applied to the electrode 5, and the socket-head bolt 1 in turn transmits radiating energy to the radiating bar transmitter 7, which is preferably comprised of Beryllium or Aluminum, and which has or is formed into a parabolic arc or has a parabolic face. The radiating bar transmitter 7 is positioned adjacent or fitted with a surrogate resonator 13, preferably comprised of Tantalum, and the transmitter 7 in turn transmits the radiating energy to the surrogate resonator 13. The parabolic face of the transmitter 7 preferably has a parabolic shape with a radius 14 of about 1.3 inches, enabling the transmitter 7 to provide an increase in sound wave travel and to concentrate the impact of the sound waves on the surrogate resonator 13. Without wishing to be limited by theory, it is believed that the parabolic shape of the transmitter 7 results in a focused ultrasonic cone 15 acting on the surrogate resonator 13. The maximum distance between the parabolic face of the transmitter 7 and the surrogate resonator 13 is preferably limited to about 0.2 inches to reduce the mechanical energy lost by transmission of the sound waves through the atmosphere. In one embodiment, a noble or inert gas may be used to replace the atmosphere trapped between the transmitter 7 and the surrogate resonator 13 during preparation or manufacture of the transducer/resonator assembly. The surrogate resonator 13 is preferably comprised of a metal, most preferably Tantalulm. Fabricating the surrogate resonator 13 from the metallic element Tantalum will provide the following two desirable properties: low speed of sound at V1 of 4,100 to insure that more of the mechanical energy is used to vibrate the insulator disc 4; and high resistance to corrosion. The surrogate resonator 13 is believed to reduce or eliminate sparking between the electrode 5 and the piezoelectric element 6 which saves electrical energy and substantially reduces the amount of power or energy required for the invention.

In one embodiment of the invention, at least one surface of the surrogate resonator 13, but preferably no surface of the piezoelectric element 6 (which will preferably be a ceramic piezoelectric crystal transducer element), will be in direct contact with the water to be treated according to the invention. In that embodiment, the surrogate resonator 13 will be exposed to salts and other potentially corrosive compounds, compositions and materials. Also, since water frequently contains Calcium, Calcium salt deposits or plaque on the surrogate resonator 13 surface(s) in contact with the water might occur. Tantalum by its nature collects significantly less Calcium plaque, however, than ceramic crystals. The transducer/resonator assembly operates most efficiently when its surfaces are free of deposits from the water, such as Calcium plaque.

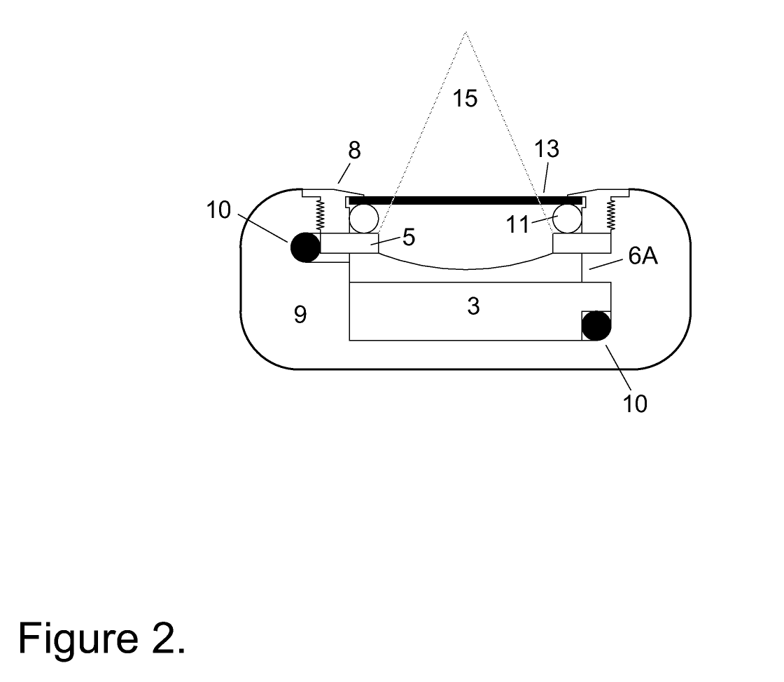

FIG. 2 shows an alternative preferred embodiment of a transducer/resonator assembly of the invention for one embodiment of the invention. In this embodiment, a piezoelectric element (or piezoelectric ceramic crystal transducer element) 6A is associated with an electrode 5, compression washer 3, and wiring 10, and is tightly squeezed in an injection-molded anti-corrosive polyvinylchloride (PVC) or Teflon® polymer shell 9, [Teflon® is a trademark of E.I. Du Pont De Nemours and Co, of Delaware.] The piezoelectric element 6A is further associated with a surrogate resonator 13 preferably comprised of Tantalum from which the piezoelectric element is separated and sealed by an “O” ring 11 preferably comprised of natural or synthetic rubber or plastic and secured by a compression screw 8. This piezoelectric element 6A is shown with a parabolic face (or parabolic dish shape), eliminating the need for a transmitter 7 with a parabolic face, while still affording the advantage of a focused ultrasonic cone 15 in transmitting energy. However, in alternative embodiments, a piezoelectric element without a parabolic face might be substituted in this transducer/resonator assembly of the invention.

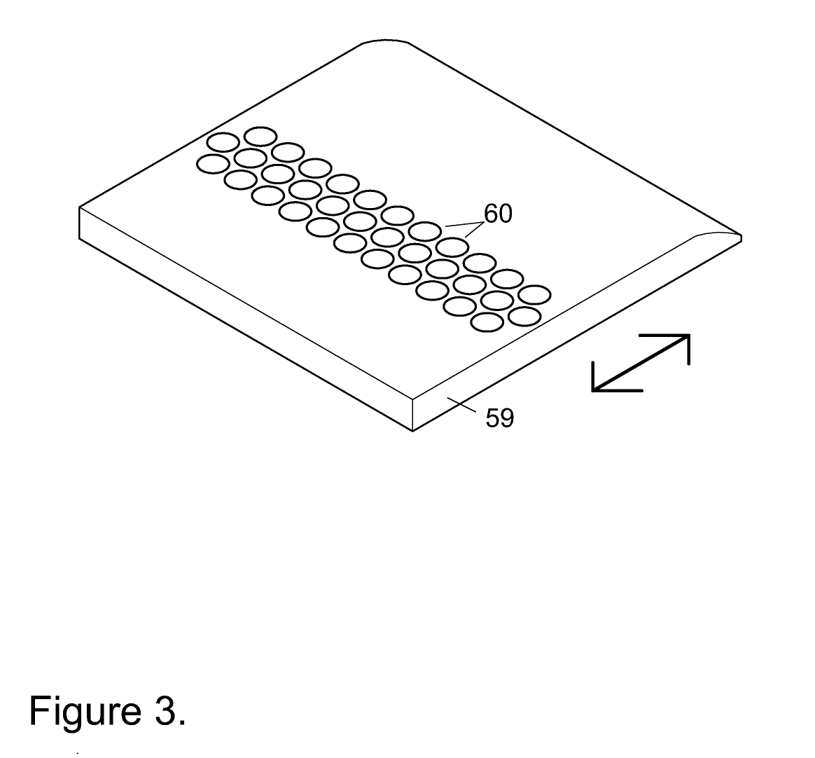

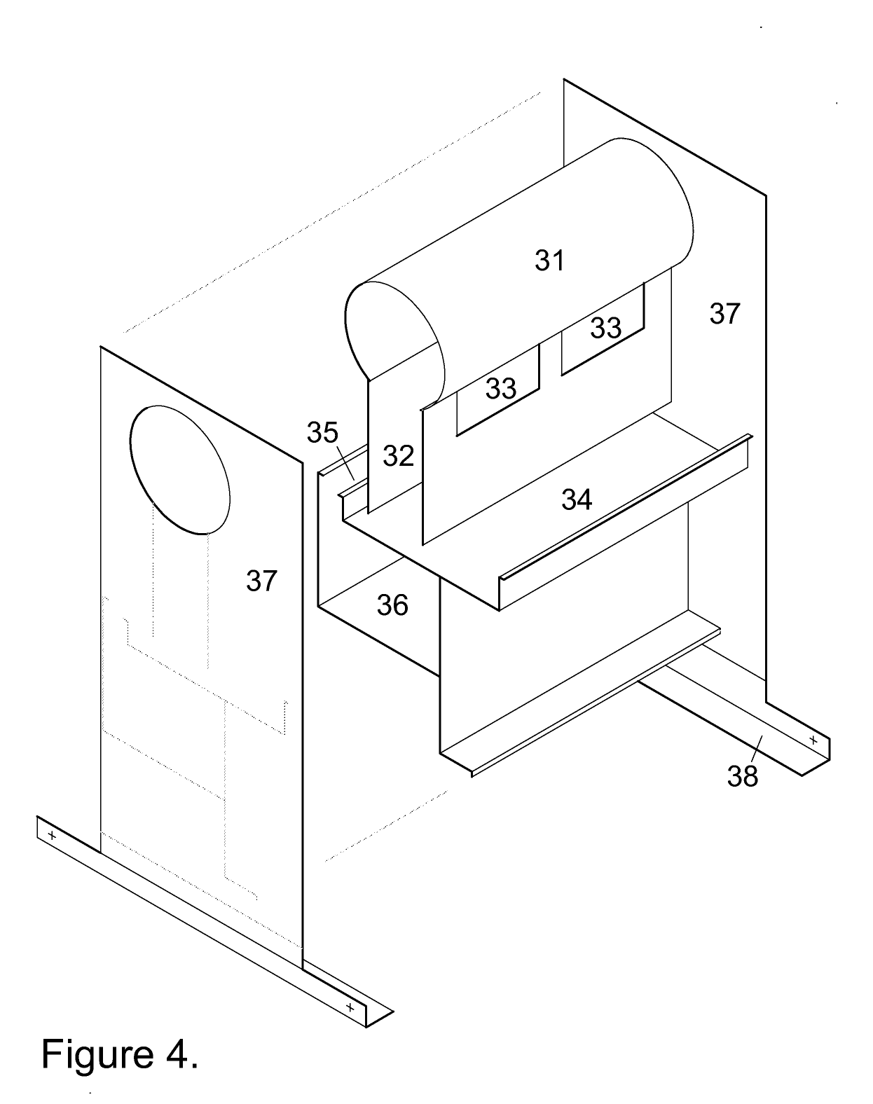

For the system of the invention, a plurality of transducer/resonator assemblies of the invention, such as alternatively illustrated in FIGS. 1 and 2, are positioned together in one of a number of many possible combinations. For example, in one embodiment, the transducer/resonator assemblies may be mounted as shown in FIG. 1, three abreast, in for example multiple rows 60 in a tray or sled 59, as shown in FIG. 3. Sleds 59 in turn may be mounted in a series of rows in a processing environment such as shown for example in FIGS. 4, 5, and 6. Such sleds 59 may be comprised of injection-molded Teflon® polymer or Noryl:Polyphenylene/PPO for non-limiting examples, or a similar substance, that does not interfere with the transducers but is also inert and resistant to corrosion by water or salts.

In the system of the invention, in a simple embodiment, sleds 59 containing multiple transducer/resonator assemblies are combined with a source for the water to be treated according to the invention, a chamber for receiving water vapor, and a condenser for the water vapor. The piezoelectric transducer/resonator assemblies convert electricity or electrical energy into vibrations or mechanical energy. These vibrations agitate the water and result in the production or release of water vapor (evaporation or vaporization of the water) above the surface of the water. This basic system may be referred to collectively or in combination as the “processing environment.” One embodiment of such a system of the invention is illustrated in FIGS. 4, 5, and 6.

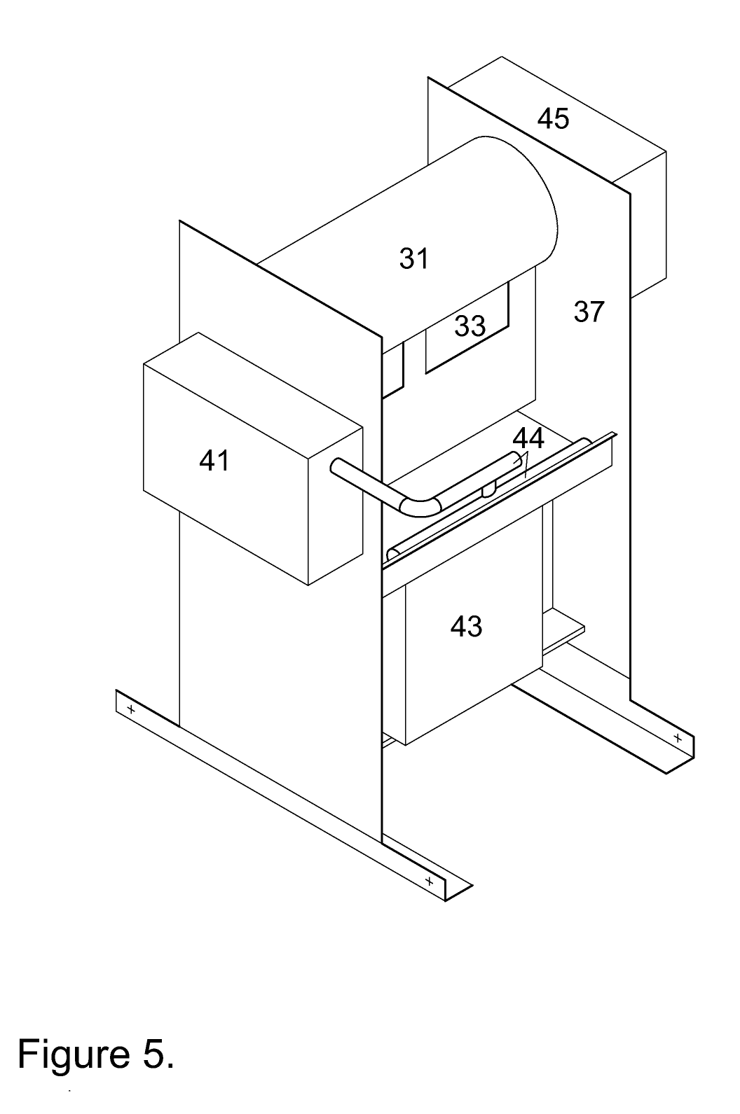

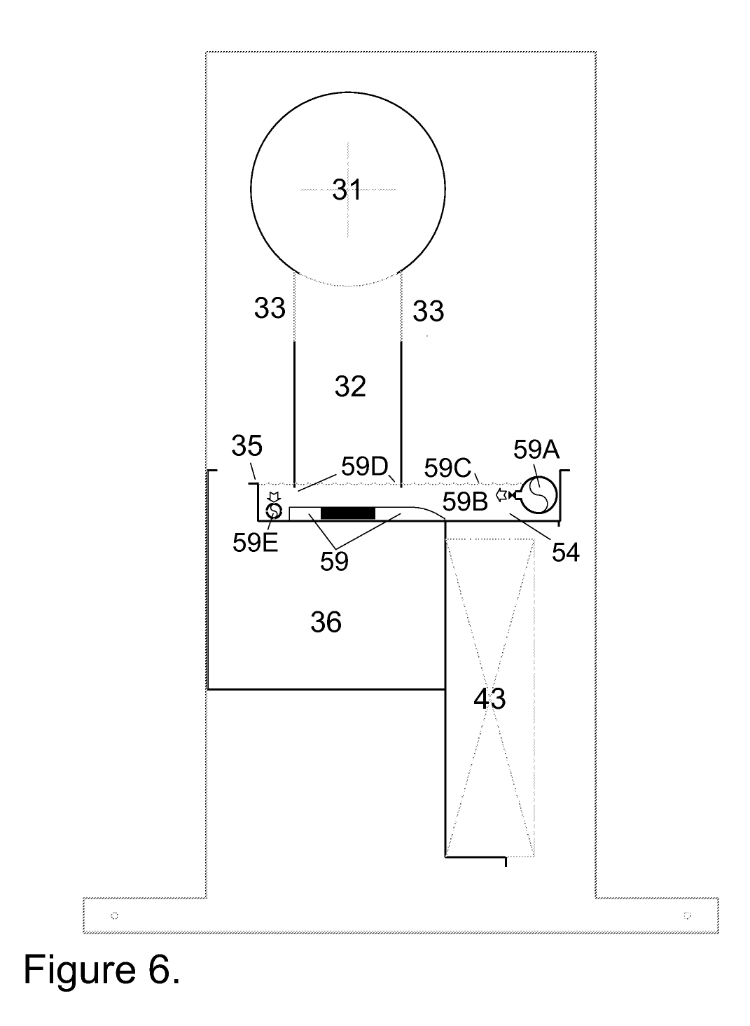

Referring to FIGS. 4, 5, and 6 illustrating one embodiment, tub 34 receives a measured or predetermined amount of water or aqueous fluid to be treated according to the invention. The water preferably has a depth in the tub 34 of about 60 to 70 millimeters (59C in FIG. 5) or a depth that affords a seal in the system or processing environment overall, as will be discussed further below. The tub 34 may be a tank or other container capable of being a source for the water for the invention. The transducer/resonator assemblies are not shown in FIGS. 4 and 5, as they lie beneath the chamber or chute 32 (which may also be called a cloud chamber) for receiving water vapor from the water, as shown in FIG. 6 (particularly see sled 59 containing transducer/resonator assemblies positioned beneath chamber 32). Most preferably, the transducer/resonator assemblies or at least the crystal piezoelectric elements 6 or 6A in the assemblies are protected from the water, except that that the surrogate resonator 13 may (or may not) have direct contact with the water. The chamber 32 preferably has or develops an airtight seal or a vacuum over the water at least while the water is vaporizing due to the resonation in the water caused by the transducer/resonator assemblies. The chamber 32 should ideally extend away from the water, up and/or out from the water, a sufficient height and/or depth from the water surface so that only vaporized water or hydrogen and oxygen atoms reach the condenser 45 or vapor duct 31, and vaporized ions or compounds having a specific gravity less than water and heavy metals will remain or fall back into the water. Without being limited by theory, it is believed that the components of the water, that is the molecules of water and salts in the water, ionize into atoms when energized by the transducer/resonator assemblies. Thus, in one embodiment, ions that enter the chamber 32 other than hydrogen and oxygen, and hence that fail to travel to the condenser 45 or vapor duct 31, might be captured for other use or processing at such lower level in the chamber 32. In one embodiment, the chamber 32 is of sufficient length to accomplish this purpose of ensuring that the water vapor reaching the condenser or vapor duct 31 is sufficiently pure water for the intended purpose of the water. Preferably near the top of the chamber 32, that is, near or at the point where the chamber 32 connects to the condenser 45 or vapor duct 31, is a means for breaking the vacuum within the chamber 32 (a vacuum results from the vaporization of the water in an airtight container). Preferably such means are gills 33 which, at least when open, allow air to enter the chamber 32. Such air changes the pressure in the chamber 32 and causes the water vapor to move to the condenser or vapor duct 31 where it will become liquid water again. If the gills 33 or other means for breaking the vacuum are not positioned near the top of the chamber 32, they should at least be positioned above the water in the water source rather than at the water surface.

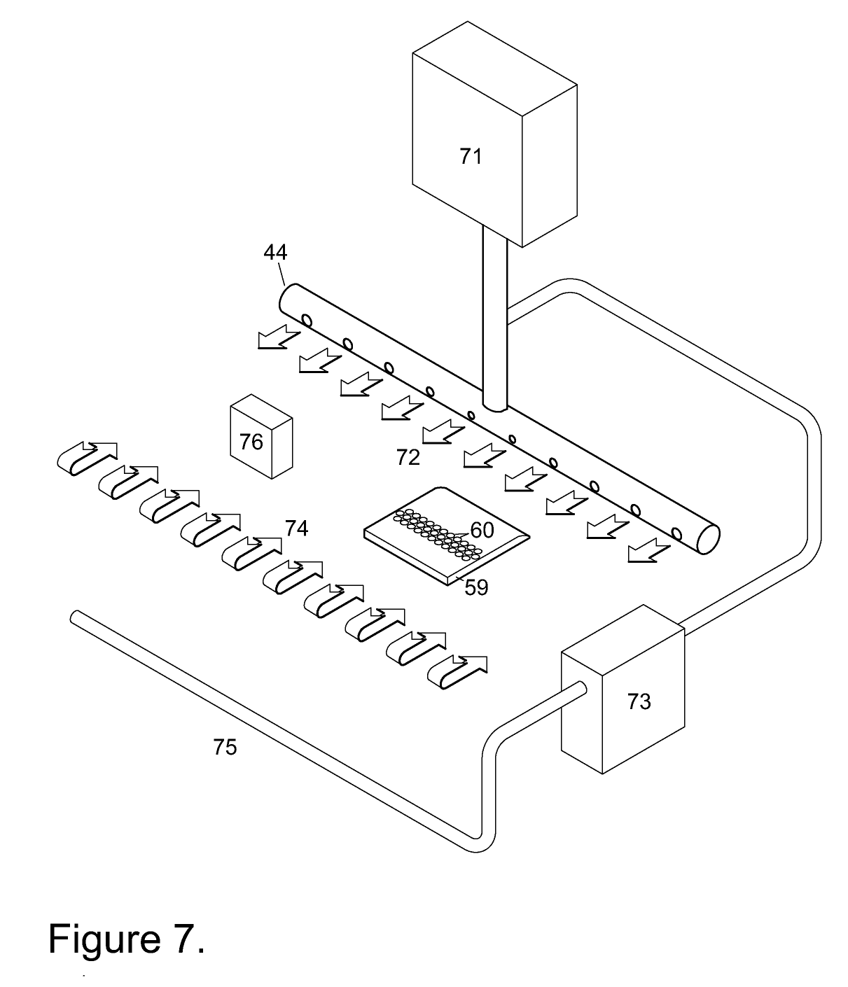

In employing the present invention to remove salts, hydrocarbons, metals, and/or solid contaminants from water or an aqueous fluid, a processing environment such as illustrated for example in FIGS. 4, 5, and 6 may be operated in a batch process or continuously. Referring again to FIGS. 4, 5, and 6, in a continuous operation, the water is introduced into and moved through the tub 34 (as a source of water for treatment according to the invention), via gravity feed or a pump, preferably a peristaltic type pump, flowing across the transducer/resonator assemblies in a transducer sled 59, and is generally maintained at a relatively constant level in the tub 34, with more water being added as water is evaporating or being vaporized and the vapor is entering the cloud chamber 32. Optionally, the water not vaporized upon a first pass through the tub 34 and across the transducer/resonator assemblies is drained off or allowed or caused to be discharged or to flow into one or more discharge receivers or tanks, such as, for example overflow spillway 35 and overflow reservoir 36. Some or all of such discharged water may in turn be re-routed to be passed through the tub 34 again one or more times, FIG. 7 illustrates one example approach for such recirculation of the water in one embodiment. In the embodiment illustrated in FIGS. 4, 5, and 6, with the water circulation or recirculation schematic shown in FIG. 7, for example, spillway 35 is used to help maintain a maximum level of water in tub 34 and overflow reservoir 36 is used to enable the overflow water to be recirculated.

In one embodiment, this continuous flow type of operation of the system of the invention may be conducted in “pulsing” type steps with water entering and leaving the tub 34 periodically rather than continuously. However, such “pulsing” is preferably so rapid as to seem continuous with respect to the water not seeming to become “still” over the transducer/resonate assemblies. Considering such a “pulsing” operation of the system of the invention, referring again to FIGS. 4, 5, and 6 for illustration, with the water circulation schematic shown in FIG. 7, peristaltic pump 71 fills the tub 34 with water to a level of about 60 to 70 millimeters above the transducer/resonator assemblies 60 in sleds 59 and pauses. The recirculation pump 73 then moves the water over the assemblies 60 in the sleds 59 as indicated by the directional arrows 72 and 74 until about 80 to 90% of the salt (or some other selected amount) has been separated from the water. The salinity meter 76 then pauses the recirculation pump 73, causes at least some water remaining in tub 34 to drain, and restarts peristaltic pump 71 for adding additional water into tub 34. This “pulsing” procedure repeats continuously.

An advantage of the processing environment of the system of the invention is that water from the water source does not remain paused, stopped or stationary over the transducer/resonator assemblies, if in direct contact with such assemblies, for any significant amount of time, if at all, during operation of the system. That is, the water does not have stationary contact with the transducer/resonator assemblies for a time sufficiently long as to result in immediate or escalated deposit of salts such as for example calcium salts from the water, onto any surface of the transducer/resonator assemblies. As discussed previously, such deposits reduce efficiency of the operation of the system and will likely inevitable occur over time. However, delaying and reducing such deposits is preferred. Stillwater enhances the recombination and/or deposit of salt crystals as does exposure to atmosphere.

Another advantage, in the embodiment illustrated in FIGS. 4, 5, and 6, is the design of the processing environment with a plurality of sleds 59 comprising transducer/resonator assemblies as discussed above, which allows for maintenance of the assemblies (as for example cleaning of any deposits such as salts on one or more surfaces and/or replacing a defective or worn out transducer) without shutting down the entire operation of the processing environment. It is contemplated that a single sled could be pulled, slid, or rolled out or otherwise removed for such maintenance while continuing the operation of the processing environment with the remaining sleds in place and the transducer/resonator assemblies in those remaining sleds remaining in operation.

### Testing

The effectiveness of the invention has been tested with a prototype, using water samples from Galveston Bay in Texas and water produced with hydrocarbons (produced water) from an oilwell in Texas. The results of those tests (as reported by an independent laboratory) are shown in the Table below.

TABLE
Salt/Ion Content of Water Samples Before and
After Treatment According to the Invention

| | Cl | Cl | SO₄ | SO₄ | | pH |
|---|---|---|---|---|---|---|
| SAMPLE | (ppm) | reduction | (ppm) | reduction | pH | reduction |
| Seawater | 15052 | N/A | 2100 | N/A | 7.28 | N/A |
| Before Treatment | | | | | | |
| Seawater | — | 100% | <2 | 99.90% | 6.92 | 72.57% |
| After Treatment | | | | | | |
| (no filter) | | | | | | |
| Seawater | 4276 | 71.59% | 620 | 70.48% | 7.2 | 1.23% |
| After Treatment | | | | | | |
| (Gills too | | | | | | |
| close to water) | | | | | | |
| Seawater | — | 100% | 61 | 97.10% | 6.78 | 7.00% |
| After Treatment | | | | | | |
| (Gills better | | | | | | |
| located) | | | | | | |
| Produced Water | 40538 | N/A | 420 | NA | 7.26 | N/A |
| Before Treatment | | | | | | |
| Produced Water | 2737 | 81.82% | 33 | 92.14% | 6.86 | 5.51% |
| After Treatment | | | | | | |

| | Cond | Cond | TDS | TDS | TCOD | TCOD |
|---|---|---|---|---|---|---|
| SAMPLE | (μS/cm) | Reduction | (ppm) | Reduction | (ppm) | Reduction |
| Seawater | 41890 | N/A | 30840 | N/A | 550 | N/A |
| Before Treatment | | | | | | |
| Seawater | 19.41 | 99.995% | 180 | 99.99% | 6 | 99.64% |
| After Treatment | | | | | | |
| (no filter) | | | | | | |
| Seawater | 13670 | 67.37% | 9380 | 69.58% | 220 | 60.00% |
| After Treatment | | | | | | |
| (Gills too | | | | | | |
| close to water) | | | | | | |
| Seawater | 1668 | 96.02% | 1220 | 96.04% | 92 | 83.27% |
| After Treatment | | | | | | |
| (Gills better | | | | | | |
| located) | | | | | | |
| Produced Water | 96020 | N/A | 75160 | N/A | 1840 | N/A |
| Before Treatment | | | | | | |
| Produced Water | 8227 | 91.43% | 5340 | 92.90% | 140 | 92.39% |
| After Treatment | | | | | | |

| | Al | Al | B | B | Ca | Ca |
|---|---|---|---|---|---|---|
| SAMPLE | (ppm) | Reduction | (ppm) | Reduction | (ppm) | Reduction |
| Seawater | 0.311 | N/A | 2.51 | N/A | 343 | N/A |
| Before Treatment | | | | | | |
| Seawater | ND | 100% | 0.0005 | 99.80% | 5.48 | 98.40% |
| After Treatment | | | | | | |
| (no filter) | | | | | | |
| Seawater | ND | 100% | 0.857 | 65.86% | 106 | 69.10% |
| After Treatment | | | | | | |
| (Gills too | | | | | | |
| close to water) | | | | | | |
| Seawater | ND | 100% | 0.155 | 93.82% | 15.1 | 95.60% |
| After Treatment | | | | | | |
| (Gills better | | | | | | |
| located) | | | | | | |
| Produced Water | ND | N/A | 9.51 | N/A | 1770 | N/A |
| Before Treatment | | | | | | |
| Produced Water | ND | N/A | 1.02 | 89.27% | 119 | 93.28% |
| After Treatment | | | | | | |
| | Cu | Cu | Fe | Fe | K | K |
| SAMPLE | (ppm) | Reduction | (ppm) | Reduction | (ppm) | Reduction |
| Seawater | 0.6491 | N/A | 0.0366 | N/A | 306.7 | N/A |
| Before Treatment | | | | | | |
| Seawater | 0.0077 | 98.81% | 0.0069 | 81.15% | ND | N/A |
| After Treatment | | | | | | |
| (no filter) | | | | | | |
| Seawater | 0.4334 | 33.23% | 0.0086 | 76.50% | 83.28 | 72.85% |
| After Treatment | | | | | | |
| (Gills too | | | | | | |
| close to water) | | | | | | |
| Seawater | 0.5552 | 14.47% | 0.0067 | 81.69% | 9.393 | 96.94% |
| After Treatment | | | | | | |
| (Gills better | | | | | | |
| located) | | | | | | |
| Produced Water | 0.1638 | N/A | 0.0525 | N/A | 454.9 | N/A |
| Before Treatment | | | | | | |
| Produced Water | 0.6337 | −296.97% | 0.007 | 86.67% | 27.06 | 94.05% |
| After Treatment | | | | | | |

| | Mg | Mg | Mn | Mn | Na | Na |
|---|---|---|---|---|---|---|
| SAMPLE | (ppm) | Reduction | (ppm) | Reduction | (ppm) | Reduction |
| Seawater | 1000 | N/A | 0.3428 | N/A | 8655 | N/A |
| Before Treatment | | | | | | |
| Seawater | 0.229 | 99.98% | 0.0035 | 98.98% | 0.9505 | 99.99% |
| After Treatment | | | | | | |
| (no filter) | | | | | | |
| Seawater | 290 | 71.00% | 0.0734 | 78.59% | 2476 | 71.39% |
| After Treatment | | | | | | |
| (Gills too | | | | | | |
| close to water) | | | | | | |
| Seawater | 30.5 | 96.95% | 0.0704 | 79.56% | 227 | 97.38% |
| After Treatment | | | | | | |
| (Gills better | | | | | | |
| located) | | | | | | |
| Produced Water | 556 | N/A | 0.3822 | N/A | 24230 | N/A |
| Before Treatment | | | | | | |
| Produced Water | 39 | 92.99% | 0.0583 | 84.75% | 1570 | 93.52% |
| After Treatment | | | | | | |

| | Ni | Ni | Zn | Zn |
|---|---|---|---|---|
| SAMPLE | (ppm) | Reduction | (ppm) | Reduction |
| Seawater | ND | N/A | 0.8866 | N/A |
| Before Treatment | | | | |
| Seawater | ND | N/A | 0.0166 | 98.13% |
| After Treatment | | | | |
| (no filter) | | | | |
| Seawater | ND | N/A | 0.2477 | 72.06% |
| After Treatment | | | | |
| (Gills too | | | | |
| close to water) | | | | |
| Seawater | ND | N/A | 0.1379 | 84.45% |
| After Treatment | | | | |
| (Gills better | | | | |
| located) | | | | |
| Produced Water | 0.2738 | N/A | 1.396 | N/A |
| Before Treatment | | | | |
| Produced Water | ND | N/A | 0.2596 | 81.40% |
| After Treatment | | | | |

The foregoing description of the invention is intended to be a description of preferred embodiments. Various changes in the details of the described systems and methods of use can be made without departing from the intended scope of this invention as defined by the appended claims.

### LIST OF ELEMENTS IN DRAWINGS

1. Socket-head bolt
2. Backing Plate
3. Compression Washers
4. Insulation Disk
5. Electrode
6. Piezoelectric Element
7. Aluminum or Beryllium Transmitter
8. Teflon® Sled Top
9. Teflon® Sled Bottom
10. Wiring
11. ‘O’ Ring
12. Gasket
13. Tantalum Resonator
14. Radius of Focused Ultrasonic Cone
15. Focused Ultrasonic Cone
21. Compression Screw
22. Backing Plate/Electrode
23. ‘O’ Ring
24. Ring Electrode
25. Piezoelectric Element
26. Teflon® Chassis
27. Wiring
28. Tantalum Resonator
31. Vapor Duct
32. Cloud Chamber
33. Gills
34. Tub
35. Overflow Spillway
36. Overflow Reservoir
37. Environment Side Panel
38. Base Foot
41. Pump Pack
43. Power Pack
44. Intake Manifold
45. Condenser
59A. Intake Manifold
59B. Service Pool
59C. Water Level
59D. Vacuum Seal
59E. Discharge Manifold
60. Transducer/Resonator Assemblies
71. Peristaltic Pump
72. Water Flow over Transducer
73. Recirculation Pump
74. Recirculation Flow
75. Recirculation Pickup
76. Salinity Meter cm What is claimed is:

1. A system for removing salts, hydrocarbons, metals and/or contaminants from water, comprising the combination of:
a supply source into which said water is loaded in a liquid state;
at least one sled integral with or associated with said supply source such that water in the supply source flows over the sled;
a plurality of ultrasonic transducers within at least one said sled,
wherein each ultrasonic transducer has associated therewith a surrogate transducer; and
wherein each ultrasonic transducer resonates within a range that causes each said surrogate transducer to resonate within a range that causes at least some of the water to evaporate or vaporize;
a condenser for the water vapor;
a chamber for directing the water vapor from the supply source into the condenser, wherein the chamber is of sufficient length that only water vapor without a significant amount of salts, metals or contaminants for the intended use, reaches the condenser;
means for flowing the water into the supply source and across the sled;
a discharge receiver for receiving any unevaporated water remaining in the supply source after the water flows across the sled; and
means for flowing any unevaporated water into the discharge receiver.

2. The system of claim 1 wherein the chamber for directing the water vapor from the supply source into the condenser comprises gills at a level for receiving an influx of air into the chamber for moving the water vapor from the chamber into the condenser, and wherein said gills are at a level in the chamber that avoids any outflow of the water vapor or water, and avoids any outflow of any salts, metals, or contaminants, into the external atmosphere through the gills, and wherein said gills are at a level in the chamber that enables only water vapor, without a significant amount of salts, metals, or contaminants for the intended use, to move to the condenser.

3. The system of claim 1 wherein water flows continuously across the sled.

4. The system of claim 3 wherein water continuously enters the supply source and continuously exits the supply source so that the water level in the supply source remains substantially constant.

5. The system of claim 1 further comprising an overflow drain for the water from the supply source, to ensure the water maintains a specific depth in the supply source.

6. The system of claim 5 wherein the depth of water in the supply source is about 60 to 70 millimeters.

7. The system of claim 1 comprising at least two sleds and each sled is removable independently of the other so that one sled may be removed without ceasing the flow of water across the other sled.

8. The system of claim 1 wherein the means for flowing water into the supply source comprises a peristaltic pump.

9. The system of claim 1 wherein the continuous flow of water comprises a pulsing of influx and egress of water through the supply source.

10. The system of claim 1 wherein the ultrasonic transducers resonate within the range of about 20,000 to about 30,000 Hz.

11. The system of claim 1 further comprising a flush tank and dispenser comprising cleaner for periodically cleaning the chamber that directs the water vapor from the supply source into the condenser.

12. The system of claim 1 wherein the chamber further comprises at least one baffle to prevent water and/or salts and/or heavy metals from entering the condenser.

13. The system of claim 1 further comprising a means for returning water from the holding or discharge tank back into the supply source for at least one repeat flow of the water across the sled.

14. The system of claim 1 wherein each sled comprises at least 3 and no more than about 60 transducers.

15. The system of claim 1 wherein the transducers are mounted in an inert polymer.

16. The system of claim 1 wherein the surrogate transducer is in immediate contact with water in the supply source.

17. The system of claim 16 wherein the surface of the surrogate transducer in contact with the water comprises Beryllium and/or Tantalum.

18. The system of claim 1 wherein the ultrasonic transducers have a parabolic curved shape.

19. The system of claim 1 further comprising a transmitter for each ultrasonic transducer.

20. The system of claim 19 wherein the transmitter has a parabolic curved shape.

21. The system of claim 19 wherein a noble gas fills the space between the transmitter and the surrogate resonator.

22. The system of claim 2 wherein the gills are above the water supply and removed from the water surface.

23. A method for enhancing the recovery of hydrocarbons from a subterranean formation comprising:
producing hydrocarbons and aqueous fluid from the subterranean formation;
treating the aqueous fluid by removing salts and/or heavy metals from the aqueous fluid employing the system of claim 1; and
injecting at least some of the treated aqueous fluid into the subterranean formation.

24. A method for removing salts, metals and/or contaminants from an aqueous fluid, the method comprising flowing the fluid across at least one ultrasonic transducer having associated therewith a surrogate transducer and the ultrasonic transducer resonating within a range that causes the surrogate transducer to resonate within a range that causes the water to evaporate or vaporize into a chamber that enables cloud formation and condensation of water, leaving behind any significant amount of the salts, metals and contaminants for the intended use of the water, wherein the ultrasonic transducer has a parabolic face or is associated with a transmitter having a parabolic face for enhancing the efficiency of the ultrasonic transducer so as to make the method economical.

25. The method of claim 24 wherein the chamber that enables cloud formation comprises gills for introducing air to cause the water vapor to condense.
